(19) United States
(12) Patent Application Publication
(10) Pub. No.: US 2008/0229677 A1
(43) Pub. Date: Sep. 25, 2008

(54) Flashing assembly for inhibiting moisture intrusion

(76) Inventors: James A. McCoy, Las Vegas, NV (US); Harold A. McCoy, Las Vegas, NV (US)

Correspondence Address: James P. Broder;Roeder & Broder LLP, 9915 Mira Mesa Blvd. Suite 300, San Diego, CA, 92131, US

(21) Appl. No.: 12/011,141

(22) Filed: Jan. 23, 2008

Related U.S. Application Data
(60) Provisional application No. 60/919,062, filed on Mar. 19, 2007.

(51) Int. Cl. E06B 7/14

(52) U.S. Cl. 52/58; 52/741.4

(57) ABSTRACT

A flashing assembly (16) for inhibiting fluid movement between an outer frame (230) that defines a building opening (232), and a building feature (14) includes a flashing substrate (248), a first sealer (256) and a second sealer (260). The flashing substrate (248) is secured to the outer frame (230). The flashing substrate (248) has a first edge (380), a first side (378) and a second side (379) opposite the first side (378). In one embodiment, the first sealer (256) is positioned on the first side (378) at a first distance (390) from the first edge (380). In some embodiments, the second sealer (260) is positioned on the second side (379) at a second distance (392) from the first edge (380). The second distance (392) is different than the first distance (390). The flashing substrate (248) can include a first crease (254) that is positioned at a third distance (394) from the first edge (380) that is greater than the first distance (390) and less than the second distance (392). In another embodiment, the flashing substrate includes a second crease (268) that is positioned at a fourth distance (396) from the first edge (380) that is greater than the first distance (390) and less than the second distance (392). The flashing substrate (248) can include a first layer (250) and a second layer (252). The first layer (250) has a first width (382) and the second layer (252) has a second width (384) that is greater than the first width (382). In one embodiment, no portion of the flashing assembly (16) extends directly between the building opening (232) and the building feature (14).

### RELATED APPLICATION

This application claims benefit under 35 U.S.C. § 119(e) from U.S. Provisional Patent Application Ser. No. 60/919,062, filed Mar. 19, 2007, the entire contents of which are expressly incorporated herein by reference to the extent permitted.

### BACKGROUND

Moisture intrusion from the exterior into the interior of a building quite commonly occurs around windows and doors. Many windows and doors include a continuous nailing flange, which is used to secure the window or door to a building's rough opening or framing. For instance, a window can be placed in the rough opening from the outside can be secured by driving nails or screws through the nailing flange into the framing of the building. The window or door installation is typically integrated with flashing materials, such as various paper materials in an attempt to create a watertight barrier to prevent moisture penetration. Installation of windows is often performed from ladders or scaffolding at various levels above the ground. Unfortunately, flashing materials are often misaligned or applied in an inconsistent manner that leaves wrinkles or voids in the materials, which can cause leaks, i.e., direct water pathways to the underlying building materials.

Conventional flashing methods and materials are not altogether satisfactory. For example, many flashing assemblies actually act as channels that lead water or other moisture from the exterior to the framing of the building. Certain flashing components provide a continuous pathway for water to traverse to the rough framing, which can result in mold, mildew or dry rot of the framing. Under these conditions, the window or door can ultimately fail, causing water intrusion into the interior of the building. Still other installations can involve unsealed folds, pockets or channels in the flashing materials that can act as reservoirs for standing water. Over time, this moisture can eventually migrate to the framing or the interior of the building, and can create mold, mildew, staining, rotting and/or interior damage problems.

### SUMMARY

The present invention is directed toward a flashing assembly for inhibiting fluid movement between an outer frame that defines a building opening, and a building feature positioned within the outer frame. The building feature can be one of a window and a door, as non-exclusive examples. In one embodiment, the flashing assembly includes a flashing substrate, a first sealer and a second sealer. The flashing substrate is adapted to be secured to the outer frame. In certain embodiments, the flashing substrate has a first edge, a first side and a second side opposite the first side. In one embodiment, the first sealer is positioned on the first side at a first distance from the first edge. In some embodiments, the second sealer is positioned on the second side. In one embodiment, at least a portion of the second sealer is positioned at a second distance from the first edge. In various embodiments, the second distance is different than the first distance. The distances are measured along the flashing substrate.

In one embodiment, the flashing substrate is formed from a substantially uniform material. Further, the first sealer can be adapted to adhere one portion of the flashing substrate to another portion of the flashing substrate. In one embodiment, the flashing substrate includes a first crease that is positioned at a third distance from the first edge that is greater than the first distance and less than the second distance. In another embodiment, the flashing substrate includes a second crease that is positioned at a fourth distance from the first edge that is greater than the first distance and less than the second distance. The first sealer can be positioned adjacent to the first crease. In one embodiment, no portion of the flashing assembly extends directly between the building opening and the building feature.

In one embodiment, the flashing substrate includes a first layer and a second layer. In this embodiment, the first crease can be formed at a junction between the first layer and the second layer so that the first layer is substantially parallel to and non-coplanar with the second layer. The first layer can have a first width and the second layer has a second width that is greater than the first width. The building feature can include a flange, and the first crease can be adapted to be positioned between the flange and the outer frame of the building. The first layer and the second layer can be formed as a unitary structure, or they can be formed separately from one another.

The present invention is also directed toward a building feature flashing system. In one embodiment, the building feature flashing system can include a building feature having a flange, and one of the flashing assemblies previously described. In some embodiments, the first crease is positioned adjacent to the flange.

The present invention is also directed toward one or more methods for inhibiting fluid movement between an outer frame of a building and a building feature.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a front elevation view of one embodiment of a fully installed building feature flashing system including a flashing assembly having features of the present invention;

FIG. 2A is a cross-sectional view illustrating a portion of the building feature flashing system including one embodiment of the flashing assembly, shown in a first position;

FIG. 2B is a cross-sectional view taken on line 2B-2B in FIG. 1 illustrating a portion of the building feature flashing system including one embodiment of the flashing assembly shown in a second position;

FIG. 2C is a cross-sectional view illustrating a portion of the building feature flashing system including an alternative embodiment of the flashing assembly, shown in the first position;

FIG. 3A is a perspective cross-sectional view of one embodiment of the flashing assembly illustrated in an unfolded position;

FIG. 3B is a perspective cross-sectional view of the flashing assembly illustrated in FIG. 3A, shown in the first position;

FIG. 3C is a cross-sectional view of the flashing assembly illustrated in FIG. 3A, shown in the second position;

FIG. 4A is a front elevation view of a building including a building opening and a portion of one embodiment of the flashing assembly in the first position, including a sill flashing;

FIG. 4B is a front elevation view of the building including the building opening and a portion of one embodiment of the flashing assembly in the first position, including a sill flashing and two jamb flashings;

FIG. 4C is a front elevation view of the building including the building opening, a building feature and a portion of one embodiment of the flashing assembly in the first position, including a sill flashing and two jamb flashings; and

FIG. 4D is a front elevation view of the building including the building opening, the building feature and a portion of one embodiment of the flashing assembly in the second position, including a sill flashing and two jamb flashings.

### DESCRIPTION

The present invention is directed toward a system and method for inhibiting water or other moisture from reaching the framing or interior of a building at or around a building feature. As used herein, the term building feature is intended to mean any opening through the exterior of a building, such as a window, door, skylight or any other similar opening that penetrates the exterior framing of a building. In one embodiment, the system and method provided herein is particularly effective for windows and doors that include a flange that is nailed, screwed or otherwise secured to the framing of the building. However, it is recognized that the system and method disclosed herein can also be equally utilized with objects that are positioned within any suitable type of building opening, including, without limitation, sliders, service boxes, plumbing boxes, hot water covers, etc. It is understood that although the embodiments described herein specifically refer to a window for ease of discussion, no limitations are intended thereby. It is recognized that the present invention can be used with any suitable building feature having a flange.

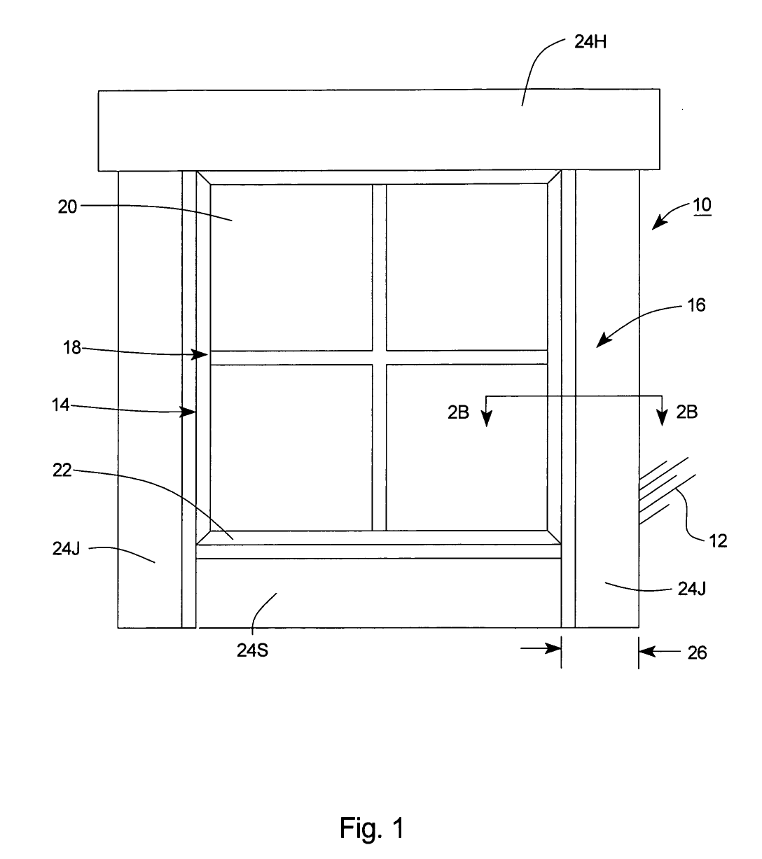

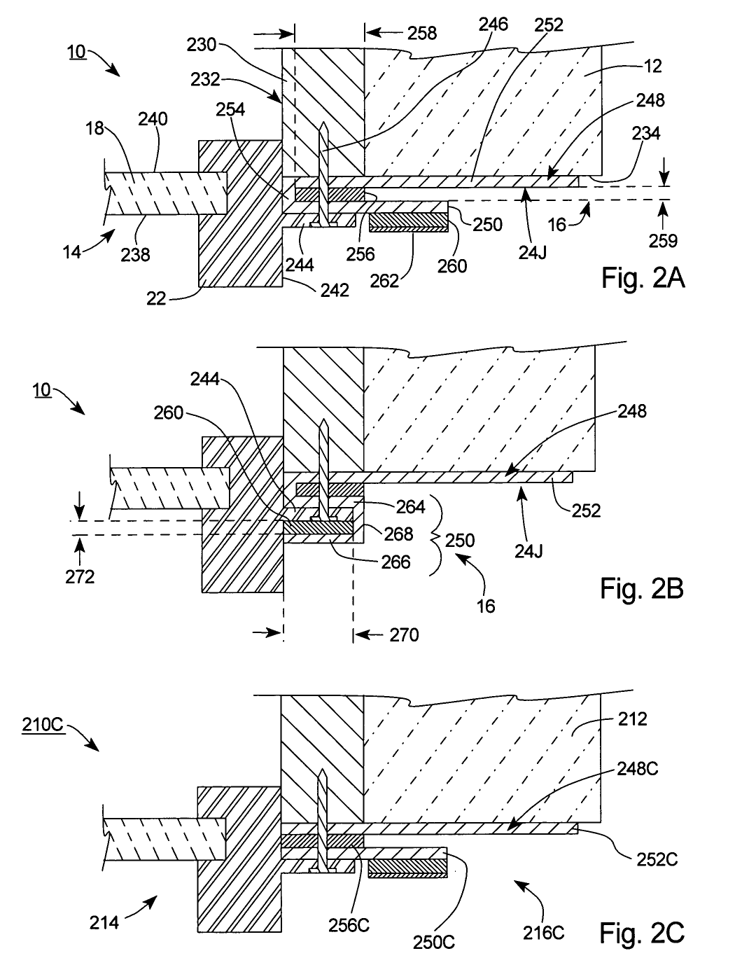

FIG. 1 is a front elevation view of a portion of a building feature flashing system 10 including a portion of a building 12, a building feature 14 and one embodiment of a flashing assembly 16 that is fully installed. The building 12 includes an outer frame 230 (illustrated in FIG. 2A) that defines a building opening 232 (illustrated in FIG. 2A). In the embodiment illustrated in FIG. 1, the building feature 14 is a window assembly (sometimes also referred to herein as a window 14). The window 14 is positioned within the building opening 232 of the building 12. Typically, the outer frame 230 is formed from wood, metal or any other suitably rigid materials that can accept one or more nails, screws or other fasteners used to secure the window 14 within the building opening 232.

In the embodiment illustrated in FIG. 1, the window 14 includes a glazing unit 18 that can include one or more lites 20 and an inner frame 22. The inner frame 22 supports and/or retains the glazing unit 18. The type of window 14 that can be used with the present invention can vary. For example, the window 14 can be fixed or operable. Further, the window 14 can be a casement window, a double hung window, or any other suitable type of window 14. Additionally, the window 14 can have any suitable shape, such as rectangular, triangular, trapezoidal, hexagonal, oval, circular, octagonal, etc.

In this embodiment, the flashing assembly 16 can include a plurality of flashing sections, including a sill flashing section 24S, two jamb flashing sections 24J and a head flashing section 24H. In alternative embodiments, the flashing assembly 16 can omit one or more flashing sections 24S, 24J, 24H. In still other embodiments, the number of each flashing section 24S, 24J, 24H can vary from that shown in FIG. 1. The flashing sections 24S, 24J, 24H, as installed as illustrated in FIG. 1, can each have an overall width 26 that is substantially similar or identical to one another. Alternatively, the overall width 26 of the installed flashing sections 24S, 24J, 24H can be different from one another.

Typically, the sill flashing section 24S is installed first, the jamb flashing sections 24J are installed next, and the head flashing section 24H is installed last (as described in greater detail below), so that the flashing sections 24S, 24J, 24H are installed in what is commonly known in the art as a “weatherboard” fashion.

FIG. 2A is a cross-sectional view illustrating a portion of the building feature flashing system 10 shown in FIG. 1, including one embodiment of the flashing assembly 16 shown in a first position. It should be noted that the Figures provided herein are not necessarily to scale, but are provided to more easily illustrate the features of the present invention which would otherwise be difficult to illustrate due to the relative dimensions of the structures. Further, any specific dimensions described herein are provided as examples of possible sets of dimensions, and are not intended to be limiting in any manner.

In the embodiment illustrated in FIG. 2A, the flashing assembly 16 includes the jamb flashing section 24J. It is recognized that although only the jamb flashing section 24J is illustrated in FIG. 2A, in various embodiments, this illustration can also be representative of the sill flashing section 24S (illustrated in FIG. 1) and/or the head flashing section 24H (illustrated in FIG. 1) in the first position.

In one embodiment, the first position is not the fully installed position, but is an intermediate position during the process of installation (also sometimes referred to as the process of “flashing”) of the window 14 within the building opening 232. In this embodiment, the building feature flashing system 10 includes the building 12, the window 14 and the flashing assembly 16. The building 12 includes a building exterior surface 234, a building interior surface (not shown in FIG. 2A) and the outer frame 230. The outer frame 230 defines the building opening 232. The window 14 includes the glazing unit 18 and the inner frame 22. In one embodiment, the glazing unit 18 has an exterior unit side 38 and an interior unit side 240 that is opposite the exterior unit side 238. The inner frame 22 includes a perimeter 242 and a flange 244 (also commonly referred to in the art as a nailing fin) that extends generally in a direction away from the perimeter 242. The flange 244 has a flange length 245 that extends around at least a portion of the perimeter 242. The flange 244 is nailed, screwed or otherwise secured to the outer frame 230 with one or more building feature fasteners 246. Suitable building feature fasteners 246 can include nails, screws, staples and the like.

In the embodiment illustrated in FIG. 2A, the flashing assembly 16 includes a flashing substrate 248 having a first layer 250 and a second layer 252. In the first position, the first layer 250 is at least partially positioned between the flange 244 and the outer frame 230. In addition, the first layer 250 is positioned in closer proximity to the flange 244 than the second layer 252. Further, the second layer 252 is positioned in closer proximity to the outer frame than the first layer 250. When the flashing assembly 16 is in the first position as illustrated in FIG. 2A, the first layer 250 is substantially parallel to the second layer 252. In the embodiment illustrated in FIG. 2A, the first layer 250 and the second layer 252 are at least partially formed from a continuous piece of material. Additionally, in the embodiment illustrated in FIG. 2A, the flashing substrate 248 includes a first crease 254 positioned at the junction of the first layer 250 and the second layer 252. In one embodiment, the flashing substrate 248 is prefolded to include the first crease 254.

In certain embodiments, the flashing substrate 248 is formed from a weatherproof, waterproof and/or water-resistant material that inhibits or prevents moisture penetration through the flashing substrate 248. In one embodiment, the flashing substrate 248 is formed from a substantially uniform material. In certain embodiments, the flashing substrate 248 is formed from a material that is substantially impervious and/or impermeable to water and other fluids. In one non-exclusive example, the flashing substrate 248 can be formed from a polyester material that is rip or tear-resistant. Alternatively, the flashing substrate 248 can be formed from any suitable material that can shed or divert fluid away from the outer frame 230.

In the embodiment illustrated in FIG. 2A, the flashing assembly 16 can also include a first sealer 256 that is positioned directly between a portion of the first layer 250 and a portion of the second layer 252. The first sealer 256 can include a self-sealing adhesive material that seals around any penetration that extends through and/or between the first layer 250 and the second layer 252. For example, in the embodiment illustrated in FIG. 2A, the fastener 246 penetrates through the first layer 250 and the second layer 252, and into the outer frame 230. In this embodiment, the first sealer 256 seals around the fastener 246 to inhibit moisture from moving along the fastener 246 to the outer frame 230.

The first sealer 256 can be formed from various liquid-applied sealing materials, such as butyl-based sealants, plastics, including but not limited to polyurethane-based sealers, bituthane sealers, foam sealers, or any other suitable liquid or solid caulking and/or sealant materials known to those skilled in the art of sealing around penetrations. In an alternative embodiment (not shown), no aperture sealer 256 is used between the first layer 250 and the second layer 252.

The dimensions of the first sealer 256 can vary depending upon the design requirements of the building feature flashing system 10. In one embodiment, the aperture sealer can have a cross-sectional width 258 of between 0.25 inches and 4.0 inches. In non-exclusive alternative embodiments, the width 258 of the first sealer 256 can be at least approximately 0.5 inches, 1 inch, 1.5 inches, 2.0 inches, 2.5 inches or 3.0 inches. Still alternatively, the width 258 of the first sealer 256 can be greater than 4.0 inches or less than 0.25 inches. A thickness 259 (measured in a direction directly between the first layer 250 and the second layer 252) of the first sealer 256 can likewise vary. In one embodiment, the thickness 259 of the first sealer 256 can be at least approximately 40 mils. In non-exclusive alternative embodiments, the thickness 259 of the first sealer 256 can be at least approximately 1 mil, 2 mils, 5 mils, 10 mils, 20 mils, 80 mils or 160 mils.

In the embodiment illustrated in FIG. 2A, the first layer 250 can also include a second sealer 260 and a removable second sealer cover 262. As explained in greater detail below, the second sealer 260 can ultimately cover a portion of the flange 244 and/or the fastener 246 so that moisture penetration in and around the fastener 246 is inhibited. In one embodiment, the second sealer 260 can be adhered to the flange 244 and/or the fastener 246 during installation of the window 14. The second sealer cover 262 is provided to inhibit premature adhesion of the second sealer 260 to any other surface. During installation of the window 14, the second sealer cover 262 is removed to expose the second sealer 260 and allow adhesion to the desired portion of the window 14, such as the flange 244 and/or the fastener 246.

FIG. 2B is a cross-sectional view taken on line 2B-2B in FIG. 1 illustrating the building feature flashing assembly 10 including the flashing assembly 16 shown in a second position. It is recognized that although only the jamb flashing section 24J is illustrated in FIG. 2B, in various embodiments, this illustration can also be representative of the sill flashing section 24S (illustrated in FIG. 1) and/or the head flashing section 24H (illustrated in FIG. 1) in the second position. As illustrated in FIG. 2B, in the second position, the flashing substrate 248 includes the first layer 250 and the second layer 252. However, in the second position, the first layer 250 is folded over the flange 244 so that the first layer 250 includes an inner section 264, an outer section 266 and a second crease 268.

In one embodiment, the inner section 264 is positioned between the flange 244 and the second layer 252. The outer section 266 is positioned on an opposite side of the flange 244 from the inner section 264. The second crease 268 is positioned at the junction between the inner section 264 and the outer section 266. In the embodiment illustrated in FIG. 2B, the second crease 266 extends around an outside edge of the flange 244.

The second sealer 260 is adhered to an opposite side of the flashing substrate 248 from the first sealer 256. In the second position, the second sealer 260 adheres the outer section 266 of the flashing substrate 248 to one side of the flange 244. In the embodiment illustrated in FIG. 2B, the second sealer 260 also adheres to and/or covers the fastener 246 to inhibit moisture intrusion or penetration at that location. In one embodiment the second sealer 260 can have a width 270 that is between approximately 0.25 inches and 4.0 inches. In non-exclusive alternative embodiments, the width 270 of the second sealer 260 can be at least approximately 0.5 inches, 1.0 inch, 1.5 inches, 2.0 inches, 2.5 inches, 3.0 inches or 3.5 inches. The second sealer 260 can have a thickness 272 that can vary. In one embodiment, the thickness 272 of the second sealer 260 can be at least approximately 40 mils. In non-exclusive alternative embodiments, the thickness 272 of the second sealer 260 can be at least approximately 1 mil, 2 mils, 5 mils, 10 mils, 20 mils, 80 mils or 160 mils.

The second sealer 260 can be formed from various liquid-applied sealing materials, such as butyl-based sealants, plastics, including but not limited to polyurethane-based sealers, bituthane sealers, foam sealers, or any other suitable liquid or solid caulking and/or sealant materials known to those skilled in the art.

FIG. 2C is a cross-sectional view illustrating a portion of an alternative embodiment of the building feature flashing system 210C, including one embodiment of the flashing assembly 216C shown in a first position. In this embodiment, the flashing substrate 248C is formed from at least two separate pieces of flashing material. For example, the first layer 250C can be formed separately from the second layer 252C so that the layers 250C, 252C are adhered to one another during installation and/or flashing of the window or other building feature 214. In this embodiment, the second layer 252C is first secured to the building 212, and the first layer 250C is then secured to the second layer 252C using a first sealer 256C or another adhesive material, a fastener (not shown), and/or any other suitable means. The remainder of the installation of the window 214 can proceed as described relative to the one-piece type of flashing substrate 248A provided herein, such as that illustrated in FIGS. 2A and 2B, for example.

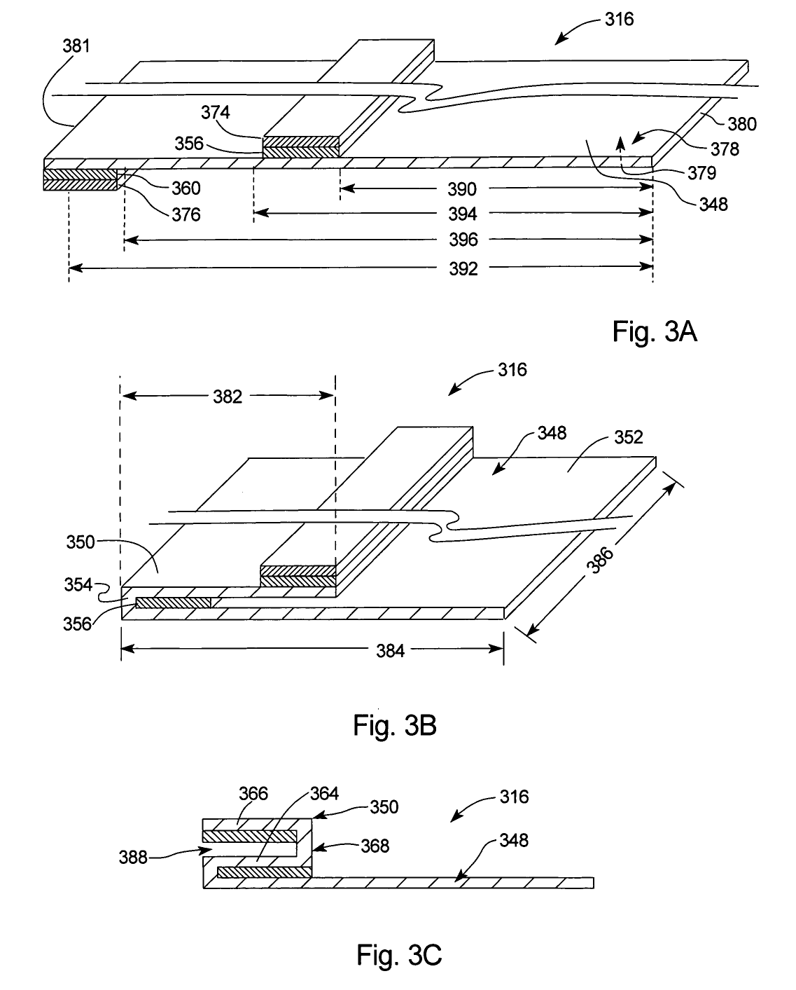

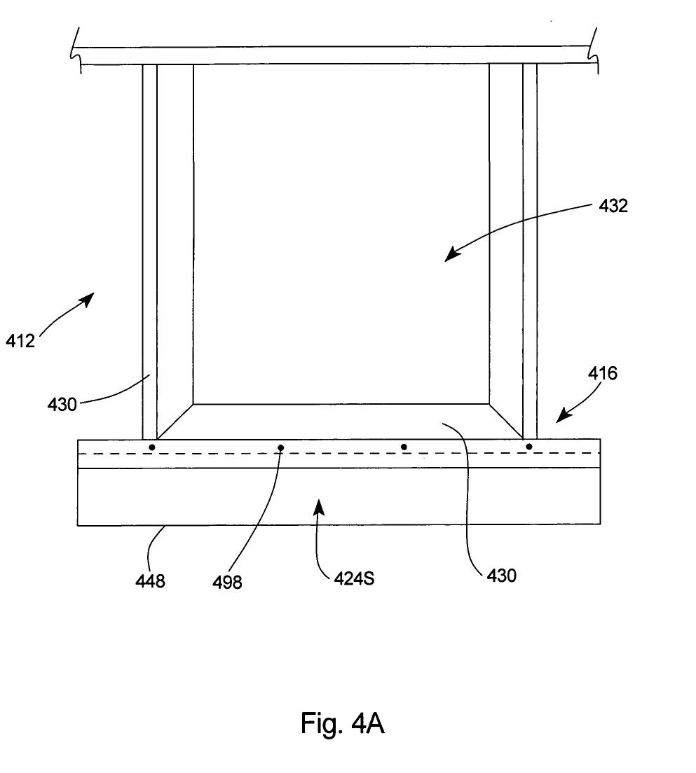

FIG. 3A is a perspective, cross-sectional view of one embodiment of the flashing assembly 316 illustrated in an unfolded position. In this embodiment, the flashing assembly 316 includes one or more of the flashing substrate 348, a first sealer 356, a first sealer cover 374, a second sealer 360 and a second sealer cover 376. The flashing substrate includes a first side 378, an opposing second side 379, a first edge 380 and a second edge 381. In the embodiment illustrated in FIG. 3A, the first sealer 356 and the first sealer cover 374 are on opposing sides of the flashing substrate 348 from the second sealer 360 and the second sealer cover 376. The second edge 381 is adjacent to the second sealer 360. In the embodiment illustrated in FIG. 3A, the first sealer 356 is more proximate the first edge 380 than the second sealer 360. It is recognized that the structures shown in the Figures are provided for discussion purposes, and that the positioning shown in the Figures is intended to be representative only, and is not intended to be limiting in any manner. It is further recognized that the positioning of the structures in the Figures is not illustrated to scale.

In this embodiment, the first sealer cover 374 removably covers the first sealer 356 on the first side 378 of the flashing substrate 348. The second sealer cover 376 removably covers the second sealer 360 on the second side 380 of the flashing substrate 348. In an alternative embodiment, one or both of the sealer covers 374, 376 can be omitted from the flashing assembly 316.

During installation of a building feature 14 such as a window, for example, the first sealer cover 374 is removed to expose the first sealer 356. The flashing substrate 348 is folded over onto itself so that the first sealer 356 also adheres to another portion of the first side 378 of the flashing substrate 348, as illustrated and described relative to FIG. 3B.

FIG. 3B is a perspective cross-sectional view of the flashing assembly 316 illustrated in FIG. 3A, shown in the first position. In the first position, the flashing substrate 348 has been folded over onto itself, using the first sealer 356 to at least partially sealingly hold the flashing substrate 348 in the first position, as illustrated in FIG. 3B. In the first position, the flashing substrate 348 includes the first layer 350, the second layer 352 and the first crease 354, as previously described relative to FIG. 2A. Further in the first position, the first layer 350 and the second layer 352 are substantially parallel and non-coplanar with one another so that the first crease 354 forms an angle of approximately 180 degrees.

In certain embodiments, the first layer 350 has a first width 382 and the second layer 352 has a second width 384 that is greater than the first width 382. However, the precise relative dimensions of the first width 382 and the second width 384 can vary. In non-exclusive alternative embodiments, the second width 384 is at least approximately 10 percent, 25 percent, 50 percent, 100 percent, 200 percent, 300 percent or 500 percent greater than the first width 382. In another embodiment, the second width 384 is less than 10 percent greater than the first width 382. In still another embodiment (not shown), the second width 384 is less than the first width 382. In one embodiment, the first width can be approximately 3 inches, while the second width can be approximately 9 inches, for a total of 12 inches. It is noted that the total can be less than or greater than 12 inches as required, and that the ratio of the first width 382 to the second width 384 can vary to suit the design requirements of the flashing assembly 316 and the building feature flashing system 10.

Additionally, the flashing substrate 348 can have a length 386 that varies. In one embodiment, the flashing substrate 348 can be manufactured in rolls (not shown) that have a length 386 of approximately 75 feet. Alternatively, the length 386 can be greater than or less than 75 feet. Still alternatively, the flashing substrate 348 can be pre-cut into various lengths 386 for standard or custom sized building openings 232 (illustrated in FIG. 2A).

FIG. 3C is a cross-sectional view of the flashing assembly 316 illustrated in FIG. 3A, shown in the second position. In FIG. 3C, the second sealer cover 376 has been removed for clarity. In the second position, the first layer 350 of the flashing substrate 348 includes the inner section 364, the outer section 366 and the second crease 368. In one embodiment, the second crease 368 is positioned at the junction between the inner section 364 and the outer section 366, as previously described relative to FIG. 2B. In this embodiment, the flashing substrate 348 is formed to include a flange gap 388 that receives the flange 244 (illustrated in FIG. 2B) so that the inner section 364 and the outer section 366 are positioned on opposing sides of the flange 244.

Referring back to FIG. 3A, in one embodiment of the flashing assembly 316, the flashing substrate 348 includes four distances, including a first distance 390, a second distance 392, a third distance 394 and a fourth distance 396. Each of the distances 390-396 is measured directly along the flashing substrate 348. The first distance 390 is the distance from the first edge 380 to the first sealer 356. The second distance 392 is the distance from the first edge 380 to the second sealer 360. The third distance 394 is the distance from the first edge 380 to the first crease 354 (not illustrated in FIG. 3A, however the positioning of the first crease 354 along the flashing substrate 348 is represented in FIG. 3A). The fourth distance 396 is the distance from the first edge 380 to the second crease 368 (not illustrated in FIG. 3A, however the positioning of the second crease 368 along the flashing substrate 348 is represented in FIG. 3A).

In certain embodiments, the first distance 390 is less than the second distance 392. Further, the third distance 394 is greater than the first distance 390, and less than the second distance 392. In one embodiment, the fourth distance 396 is greater than the first distance 390, less than the second distance 392, and greater than the third distance 394. The relative positioning of the sealers 356, 360 and the creases 354, 368, and the manner in which this positioning aligns with a particular building feature 14 increases the sealing ability of the flashing assembly 16 around building features 14, and/or decreases susceptibility to water intrusion from the exterior into the interior of the building 12.

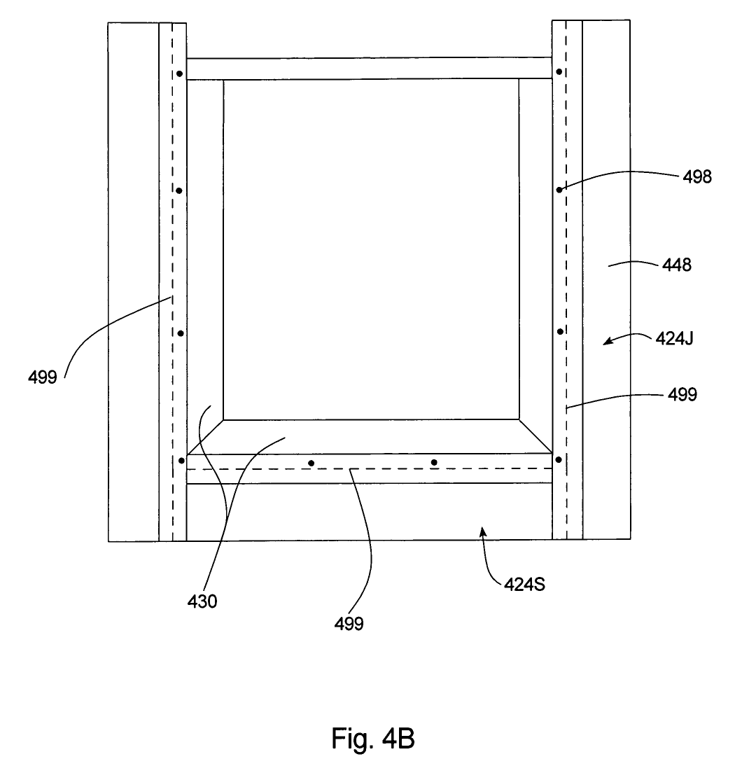

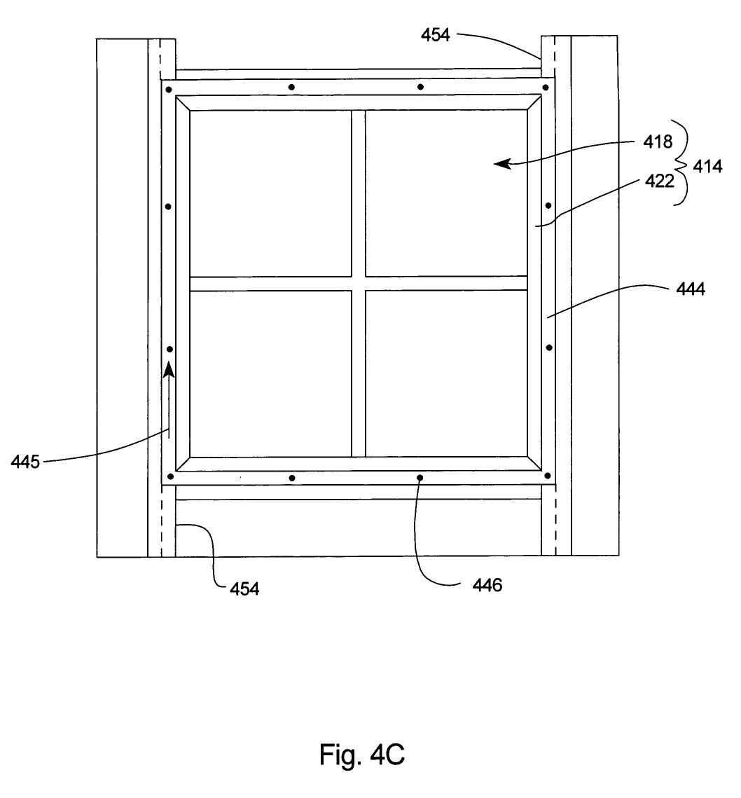

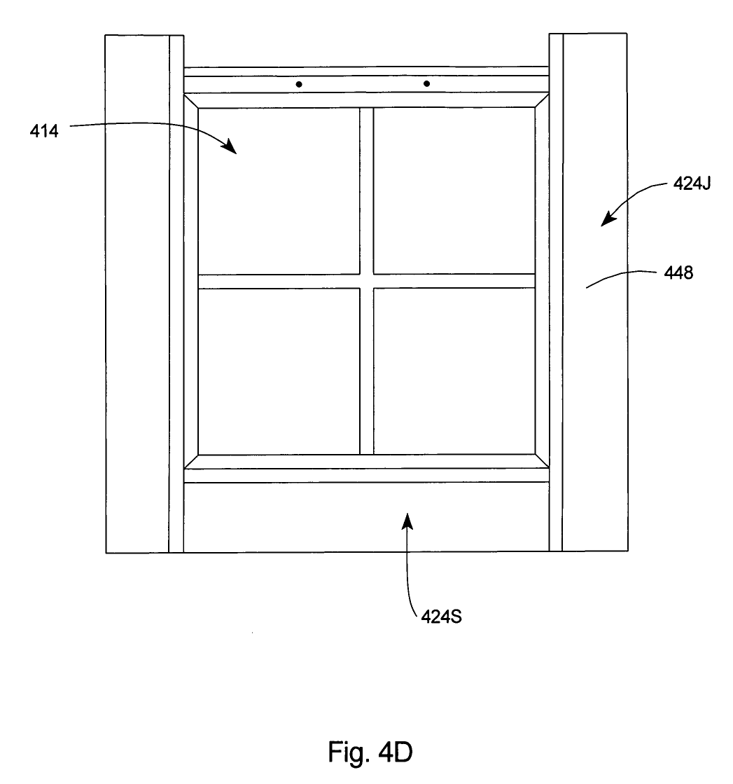

FIGS. 4A-4D illustrate front elevation views of one embodiment of a sequence of installation of the flashing assembly 416 and a building feature 414 (illustrated in FIG. 4C) into a building opening 432. FIG. 4A illustrates a portion of a building 412 including the building opening 432, the building feature 414 and a portion of one embodiment of the flashing assembly 416 illustrated in the first position. It is recognized that should a flashing assembly 416 be utilized wherein the flashing substrate 448 is in the unfolded position rather than the first position, the user can fold the flashing substrate into the first position prior to or during installation, as necessary. In this embodiment, the sill flashing 424S of the flashing assembly 416 is first fastened to the outer frame 430 with flashing fasteners 498 such as staples, nails, etc. Alternatively, the sill flashing 424S can be adhered to the outer frame 430 with an adhesive material.

FIG. 4B illustrates installation of the jamb flashing 424J to the outer frame 430 that form the window opening. In this embodiment, the flashing substrate 448 for the jamb flashing 424J is installed in a substantially similar manner as the sill flashing 424S described previously. In one embodiment, the jamb flashing 424J is positioned over portions of the sill flashing 424S in a weatherboard manner, as illustrated in FIG. 4B. The flashing substrate 448 of the jamb flashing 424J is then fastened to the outer frame 430 with flashing fasteners 498 such as staples, nails, etc. Alternatively, the jamb flashing 424J can be adhered to the outer frame 430 with an adhesive material.

FIG. 4C illustrates installation of a portion of the building feature 414, including the glazing unit 418 and the inner frame 422. The flange 444 is positioned so that the first crease 454 of each flashing substrate 448 and the first sealer 256 (illustrated in FIG. 2A) are sandwiched between the flange 444 and the outer frame 430 (illustrated in FIG. 4A). The flange 444 is then fastened to the outer frame 430 with building feature fasteners 446 to secure the building feature 414 to the outer frame 430 as illustrated in FIG. 4C.

FIG. 4D illustrates a portion of the building feature and flashing installation including positioning of the flashing substrate 448 into the second position. In the embodiment illustrated in FIG. 4D, the second sealer 260 (illustrated in FIG. 2A) is exposed by removing the second sealer cover 262 (illustrated in FIG. 2A), if any. The flashing substrates 448 of the sill flashing 424S and the jamb flashings 424J are then folded along the dashed lines 499 (illustrated in FIG. 4B) so that the flashing substrate 448 covers the building feature fasteners 446 (illustrated in FIG. 4C) at the sill and jamb locations and some or all of the flange 444 (illustrated in FIG. 4C) of the building feature 414.

Referring back to FIG. 1, the head flashing 24H is then positioned over the jamb flashings 24J in a weatherboard manner. Further, the head flashing is positioned to cover the building feature fasteners 446 (illustrated in FIG. 4C) and some or all of the flange 444 (illustrated in FIG. 4C) at the head location.

With this design, the one-piece construction of each section of the flashing assembly 12 facilitates window installation, and better inhibits moisture intrusion into the framing materials and/or the interior of the building. Additionally, because none of the flashing substrate 248 (illustrated in FIG. 2A, for example) is positioned between the inner frame 22 of the building feature 14 and the outer frame 230 (illustrated in FIG. 2A, for example) of the building 12, there is a decreased likelihood of moisture moving along the flashing substrate 248 in this area into the interior of the building 12.

While the particular flashing assembly 16 as shown and disclosed herein is fully capable of obtaining the objects and providing the advantages herein before stated, it is to be understood that it is merely illustrative of the presently preferred embodiments of the invention and that no limitations are intended to the details of the methods, construction or design herein shown and described.

What is claimed is:

1. A flashing assembly for inhibiting fluid movement between an outer frame of a building and a building feature positioned within the outer frame, the flashing assembly comprising:
a flashing substrate that is adapted to be secured to the outer frame, the flashing substrate having a first edge, a first side and a second side opposite the first side;
a first sealer positioned on the first side at a first distance from the first edge, the first distance being measured along the flashing substrate; and
a second sealer positioned on the second side, at least a portion of the second sealer being positioned at a second distance from the first edge, the second distance being measured along the flashing substrate, the second distance being different than the first distance.

2. The flashing assembly of claim 1 wherein the flashing substrate is formed from a substantially uniform material.

3. The flashing assembly of claim 1 wherein the first sealer is adapted to adhere one portion of the flashing substrate to another portion of the flashing substrate.

4. The flashing assembly of claim 1 wherein the flashing substrate includes a first crease that is positioned at a third distance from the first edge measured along the flashing substrate that is greater than the first distance and less than the second distance.

5. The flashing assembly of claim 4 wherein the flashing substrate includes a second crease that is positioned at a fourth distance from the first edge measured along the flashing substrate that is greater than the first distance and less than the second distance.

6. The flashing assembly of claim 4 wherein the first sealer is positioned adjacent to the first crease.

7. The flashing assembly of claim 4 wherein the flashing substrate includes a first layer and a second layer, the first crease being formed at a junction between the first layer and the second layer so that the first layer is substantially parallel to and non-coplanar with the second layer.

8. The flashing assembly of claim 7 wherein the first layer has a first width and the second layer has a second width that is greater than the first width.

9. The flashing assembly of claim 8 wherein the second width is at least approximately 25 percent greater than the first width.

10. The flashing assembly of claim 4 wherein the building feature includes a flange, and the first crease is adapted to be positioned between the flange and the outer frame of the building.

11. The flashing assembly of claim 1 wherein the flashing substrate includes a first layer and a second layer that is substantially parallel to and non-coplanar with the first layer.

12. The flashing assembly of claim 11 wherein the first layer and the second layer are formed as a unitary structure.

13. The flashing assembly of claim 11 wherein the first layer and the second layer are formed separately from one another.

14. The flashing assembly of claim 1 wherein the building feature is one of a window and a door.

15. A building feature flashing system including a building feature having a flange, and the flashing assembly of claim 4, the first crease being positioned adjacent to the flange.

16. A method for inhibiting fluid movement between an outer frame of a building and a building feature, the outer frame defining a building opening, the method comprising the step of:
positioning a flashing assembly between the outer frame and the building feature, the flashing assembly including (i) a flashing substrate that is adapted to be secured to the frame, the flashing substrate having a first edge, a first side and a second side opposite the first side, (ii) a first sealer positioned on the first side at a first distance from the first edge, the first distance being measured along the flashing substrate, and (iii) a second sealer positioned on the second side, at least a portion of the second sealer being positioned at a second distance from the first edge, the second distance being measured along the flashing substrate, the second distance being different than the first distance.

17. The method of claim 16 wherein the step includes positioning the flashing assembly so that no portion of the flashing assembly extends directly between the building opening and the building feature.

18. The method of claim 16 wherein the flashing substrate is formed from a substantially uniform material.

19. The method of claim 16 wherein the first sealer is adapted to adhere one portion of the flashing substrate to another portion of the flashing substrate.

20. The method of claim 16 wherein the flashing substrate includes a first crease that is positioned at a third distance from the first edge measured along the flashing substrate that is greater than the first distance and less than the second distance.

21. The method of claim 20 wherein the flashing substrate includes a second crease that is positioned at a fourth distance from the first edge measured along the flashing substrate that is greater than the first distance and less than the second distance.

22. The method of claim 20 wherein the first sealer is positioned adjacent to the first crease.

23. The method of claim 20 wherein the flashing substrate includes a first layer and a second layer, the first crease being formed at a junction between the first layer and the second layer so that the first layer is substantially parallel to and non-coplanar with the second layer.

24. The method of claim 23 wherein the first layer has a first width and the second layer has a second width that is greater than the first width.

25. The method of claim 24 wherein the second width is at least approximately 25 percent greater than the first width.

26. The method of claim 20 wherein the building feature includes a flange, and the first crease is adapted to be positioned between the flange and the outer frame of the building.

27. The method of claim 16 wherein the flashing substrate includes a first layer and a second layer that is substantially parallel to and non-coplanar with the first layer.

28. The method of claim 27 wherein the first layer and the second layer are formed as a unitary structure.

29. The method of claim 27 wherein the first layer and the second layer are formed separately from one another.

30. The method of claim 16 wherein the building feature is one of a window and a door.

31. A flashing assembly for inhibiting fluid movement between a frame of a building and a building feature positioned within the frame, the building feature including a perimeter and a flange having a flange length that extends along at least a portion of the perimeter, the flashing assembly comprising:
a first layer that is adapted to be secured to the flange, the first layer having a first length that extends along the flange length and a first width that is substantially perpendicular to the first length; and
a second layer that is positioned substantially parallel with the first layer, the second layer having a second width measured in a substantially similar direction as the first width;
a first crease that that forms a junction between the first layer and the second layer, the first crease being positioned so that the second width is greater than the first width; and
a first sealer that adheres a portion of the first layer to a portion of the second layer.
